(19) United States
(12) Patent Application Publication
(10) Pub. No.: US 2004/0248638 A1
(43) Pub. Date: Dec. 9, 2004

(54) Player-activated feature

(76) Inventor: Ghislain Dore, Drummondville (CA)

Correspondence Address: LABTRONIX CONCEPT INC., C/O OGILVY RENAULT, 1981 MC GILL COLLEGE AVENUE, SUITE 1600, MONTREAL, QUEBEC, H3A 2Y3, CA

(21) Appl. No.: 10/853,571

(22) Filed: May 26, 2004

Related U.S. Application Data
(60) Provisional application No. 60/473,270, filed on May 27, 2003.

(51) Int. Cl. A63F 13/00

(52) U.S. Cl. 463/16

(57) ABSTRACT

A method to provide a player-activated game. The present method is characterized in that the player selects an indicium among a plurality of displayed indicia cued in a one at a time manner and in a time-weighted manner. The indicium selection is completed when the player actuates a control, resulting in a stop signal being transmitted and the cuing process being stop with one of the indicia remaining cued. An outcome is established based on the indicium selected through this process. Embodiments of the method include electronic and electromechanical gaming machines and gaming-machine add-on devices.

### CROSS-REFERENCE TO RELATED APPLICATIONS

This application claims priority under 35USC§119(e) of U.S. provisional patent application 60/473,270, filed May 27, 2003, the specification of which is hereby incorporated by reference.

### TECHNICAL FIELD

The invention relates to a gaming machine and a method of applying a player-activated feature on these gaming machines.

### BACKGROUND OF THE INVENTION

The field of casino-style games and gaming machines is in constant evolution. Players are always demanding new features that may incite them to play. Such features implemented in the past include multi-hand pokers, progressive jackpots, multi-line slot machine games and mystery prizes to list a few. A particular characteristic players are seeking is to get involved to some degree in the game outcome. On the other hand, more control players have, higher are the risks for the outcome not to respect the game payout. Therefore, a balance must be reached.

Accordingly, improvements in this field are desired.

### SUMMARY OF THE INVENTION

The invention consists in a method of providing a player-activated feature in a gaming environment. Further, it consists in providing a player with a plurality of visually distinguishable indicia. The indicia are visually cued one at a time in front of the player until reception of a player-dependent stop signal. The signal is generated when a player actuates suitable input means. Consequently, the cuing process ends; the indicium currently cued at the time remains cued and becomes the selected indicium on which the outcome of the game is based. Furthermore, the indicia are cued in an uneven cuing-time manner; some being cued longer than other. It renders more difficult the selection of a precise indicium.

The method further comprises alternatives in the representation of indicia, the cuing process, indicium cuing frequencies, outcome establishment process and format, and its dependency to a primary game.

Furthermore, the invention also consists in a gaming machine comprising display means providing a plurality of distinguishable indicia to a player. The gaming machine comprises input means actuated by the player to generate a stop signal, and game controller means controlling the game play. The game controller means is adapted to visually cue the indicia one at a time in an uneven time-weighted manner. It is also adapted to stop the cuing process upon reception of a stop signal, and therefore selecting an indicium on which the game outcome will be based.

In an embodiment, the invention is further adapted to be provided either in an integrated format within a regular gaming machine or in an add-on format appended to a gaming machine.

The invention also consists in codes adapted to control a machine such as a computer to perform the present method; the codes being stored on suitable media such as a computer readable media or processor-readable memory, or communicated through an electrical or an electro-mechanic carrier signal for instance.

Accordingly, an aspect of the invention is to provide a player-activated feature in a gaming environment creating a positive incentive.

Thus, an object of the invention is to provide a feature that responds to this problem in such a way that a player may easily see his implication in the game outcome. Furthermore, the player may also learn to improve himself.

Another object is to provide such a feature while keeping control over the game payout.

Another object is to allow this feature to be easily carried out in a plurality of form, such as an independent game or as a game depending on the outcome of a primary game to be initiated.

In this specification, the terms “cuing an indicium” is intended to mean “giving to said indicium a premium importance among the other indicia” or “rendering said indicium more important in a distinguishable manner than the other indicia”. The term “time weighting” is intended to mean “providing more or less importance to an indicium through the time allowed to said indicium”.

### BRIEF DESCRIPTION OF THE DRAWINGS

Further features and advantages of the present invention will become apparent from the following detailed description, taken in combination with the appended drawings, in which:

FIG. 1 is a schematic diagram showing a perspective view of a gaming machine suitable for the present invention;

FIG. 2 is a block diagram illustrating the components of the gaming machine of FIG. 1;

FIG. 3 is a schematic diagram showing a perspective view of a second gaming machine with an add-on device suitable for the present invention;

FIG. 4 is a schematic illustration of a game layout suitable for the present invention;

FIG. 5 is a flow chart illustrating steps of the method of the present invention; and

FIG. 6 is a block diagram illustrating some of the gaming machine components illustrated on FIG. 2 in a functional manner.

It will be noted that throughout the appended drawings, like features are identified by like reference numerals.

### DETAILED DESCRIPTION OF THE INVENTION

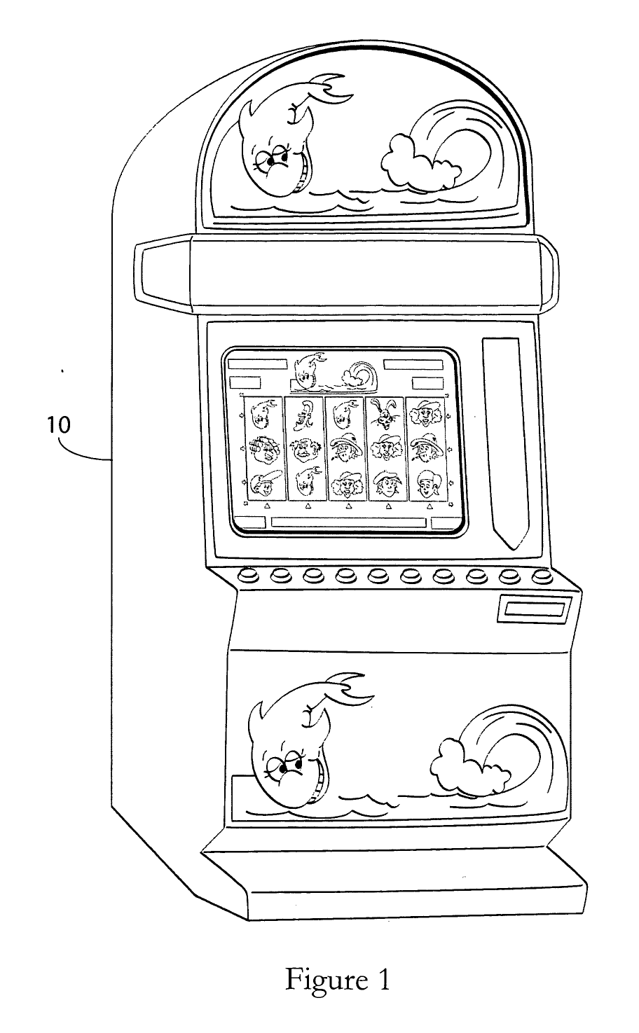

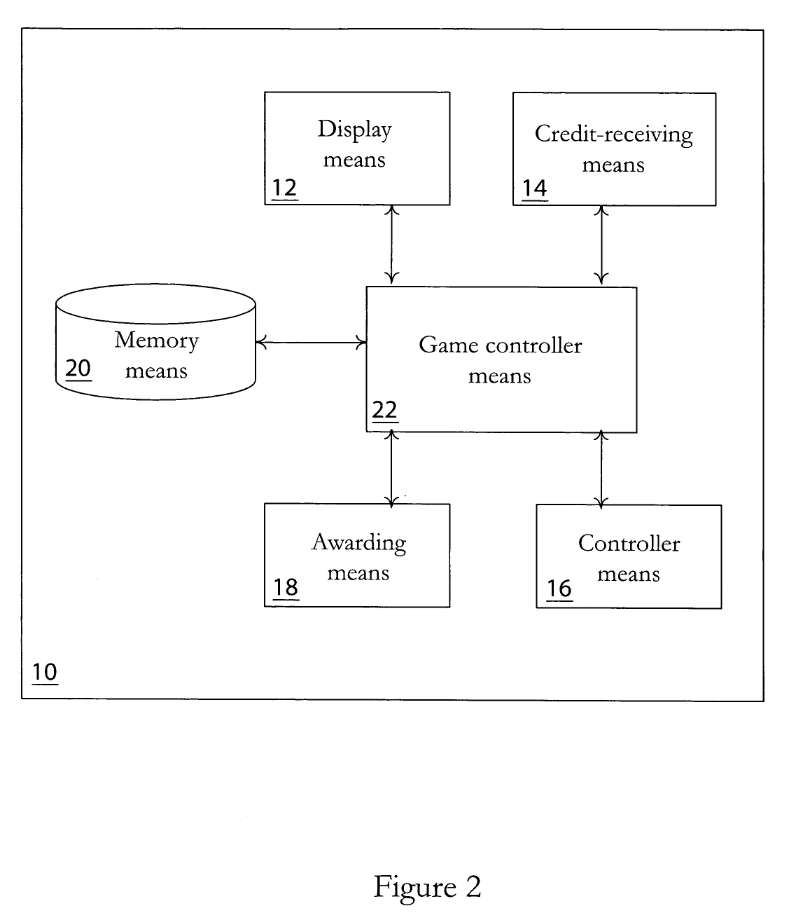

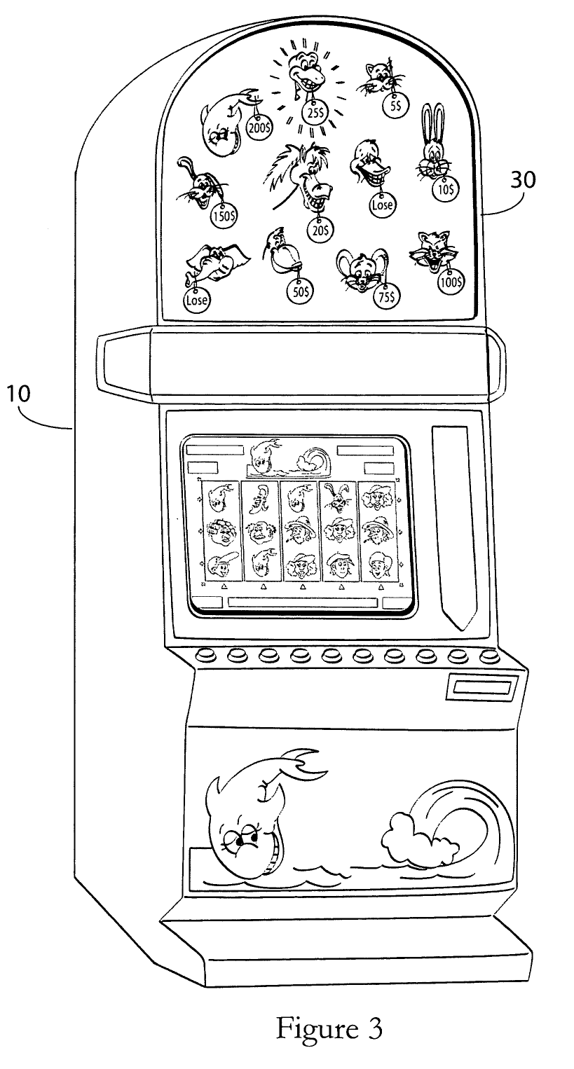

The present invention is preferably carried out on a gaming machine, as illustrated in FIGS. 1 and 2, or on a device communicatively linked to a gaming machine, as illustrated on FIG. 3. Gaming machine 10 comprises display means 12 such as a video screen, a LCD screen or mechanical reels; credit-receiving means 14 such as a card reader or a coin and/or bill acceptor; input means 16 such as buttons, levers or touch screen; awarding means 18 such as a ticket printer, a card reader or a hopper; memory means 20; and game controller means 22. In its add-on device version, the device 30 is temporarily or permanently placed on the gaming machine 10; the two apparatus 10 and 30 being communicatively linked with the device 30 being partially controlled by the gaming machine 10.

In such gaming machine 10, input means 16 receives information from the player, credit-receiving means 12 receives credit information in a suitable form from the player or an electronic source, and game controller means 22 processes the information to provide a game play through the display means 12. According to that game play, game controller means 22 may command awarding means 18 to reward the player with a prize. To provide such a game play, game controller means 22 has access to a program stored in memory means 20 and allowing it to complete game functions such as generating a representation of said play to be provided through display means 12.

The invention may also be applied in a computer program, or at a remote terminal, game information being distributed via a network, such as linked machines or the Internet, or broadcasted using an electric or electromagnetic signal.

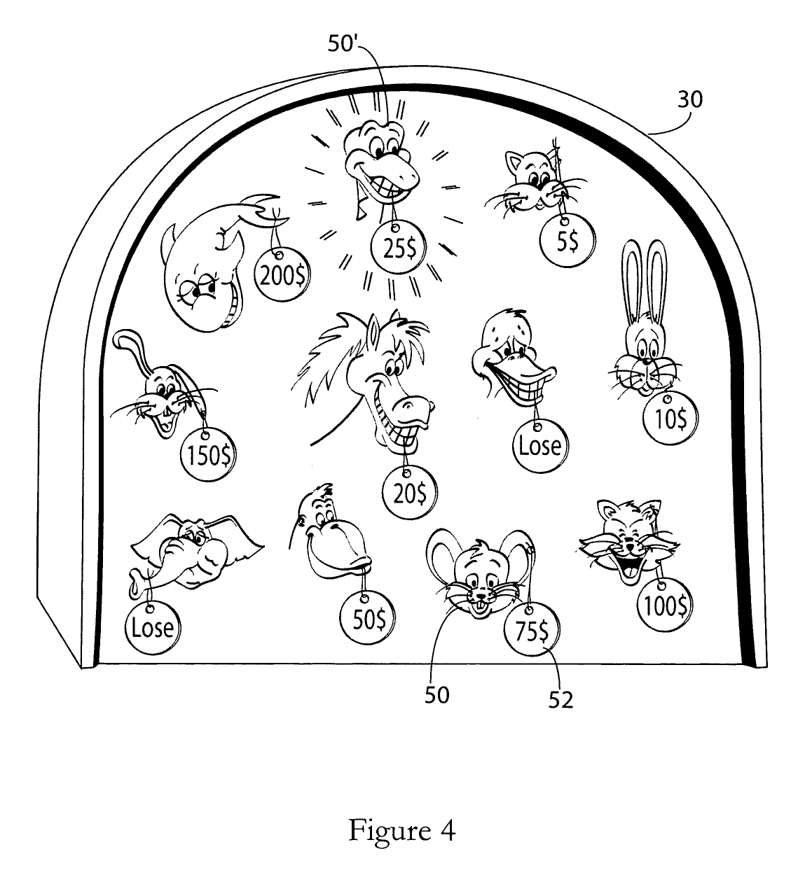

To provide a good understanding of the method of the invention, a layout for the play of the game is provided on FIG. 4. A plurality of indicia 50 is displayed, pending to be selected. The indicia 50 bear values 52 awarded to the player when selected. As illustrated, the indicia 50 are displayed in a non-organized structure, meaning the player is unable to predict the next indicium to be cued based on the indicia disposition. However, the invention contemplates the use of any other structure such a wheel or a path. Furthermore, one of the indicia 50′ is illustrated as cued. Highlighting the indicium usually does the cuing. On an electronic display, the colors of the cued indicium 50′ may be changed, a halo surrounding the cued indicium 50′ may be used, etc. In an electromechanical version wherein indicia 50 are imprinted on a glass, lamps (not shown) are usually disposed beneath the glass in indicia corresponding positions. When an indicium has to be cued, the corresponding lamp is turned on. In the latter embodiment, a lamp controller (not shown) controls lamp power; said lamp controller being controlled by the game controller means 22 of FIG. 2.

The object of the game is to select an indicium that is used to establish the game outcome. The selection process is complete when the player actuates input means 16, the indicia cued at this time remaining in its state and therefore becoming the selected indicium.

Depending on the game rules, the player may be awarded the indicium borne prize. In another version of the game (not illustrated through the layout of FIG. 4), the outcome may be determined by comparing the selected indicium with comparison data. Accordingly, it may determine if the outcome is a win and the value of said win. The time used to select the indicium may also be compared with comparison data to establish the outcome, or to modify the outcome value determined through one of the above processes for instance.

In alternative embodiments, the indicia may bear characteristics that may be matched or compared to each other according to outcome evaluation rules. The selection process may take place once, twice or as many times as necessary to establish the outcome. One skilled in the art may select peculiar limitations to provide an interesting game; these limitations depending solely on the game rules.

Afterwards, the player is awarded his prize in a suitable format. Such a format may be a monetary prize, points, tickets, etc.

To control the difficulty level for selecting a particular indicium instead of another, the cuing process is time weighted. Each indicium is cued a predetermined time after which a new indicium is cued, the cuing time varying from one indicium to another. Accordingly, by time weighting indicia that may have intrinsic values, an average value based on the cuing time may be computed. Accordingly, when using relatively short cuing periods, it becomes difficult for the player to select a particular indicium. An example is if said indicium is cued for less than a second.

Nonetheless, the present game allows players to develop skill resulting in better outcomes. Such skill may take form of better eye/hand reflex to actuate the control rapidly when the indicium is cued, or by learning to recognize the order the indicia are cued when such order exists.

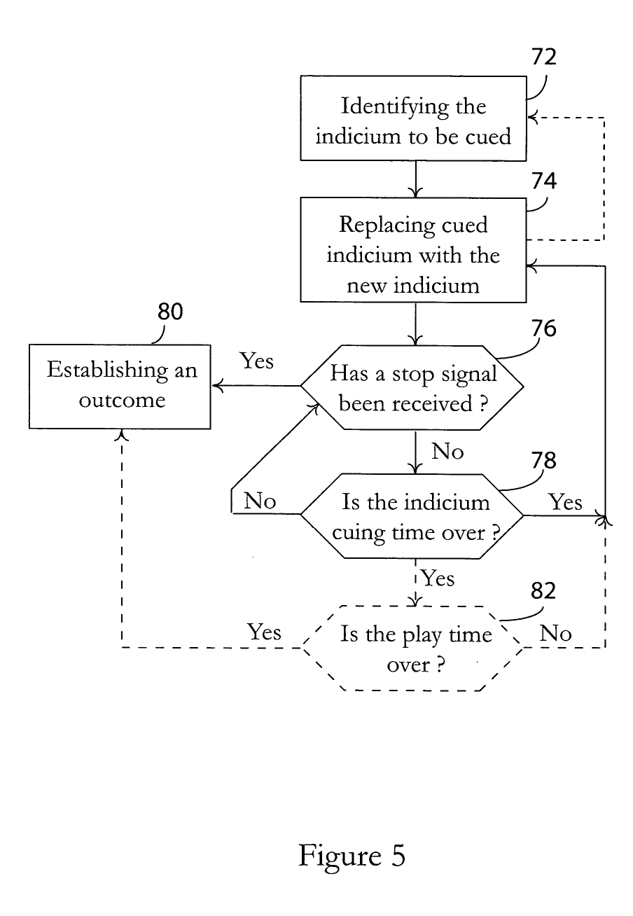

Accordingly, the method as illustrated through the flow chart of FIG. 5 includes the steps of identifying an indicium to cue and the time this cue must lapse (step 72), and synchronously ceasing cuing the currently cued indicium while initiating the cuing of the new indicium (step 74) until a stop signal is received (step 76). When said signal is received, an outcome is established (step 80) based on an evaluation of said indicium and awarded to the player. If no stop signal is received during the cuing time of an indicium (step 78), the cued indicium is replaced by a new one. As displayed in short dashed line, the information concerning the next indicium to be cued is usually retrieved during the cuing of another indicium. Furthermore, as displayed in long dashed lines, the selection process may be limited in time (step 82). Other variations may be added to the flow chart (but not shown), such as repeating the selection process to establish a single play outcome.

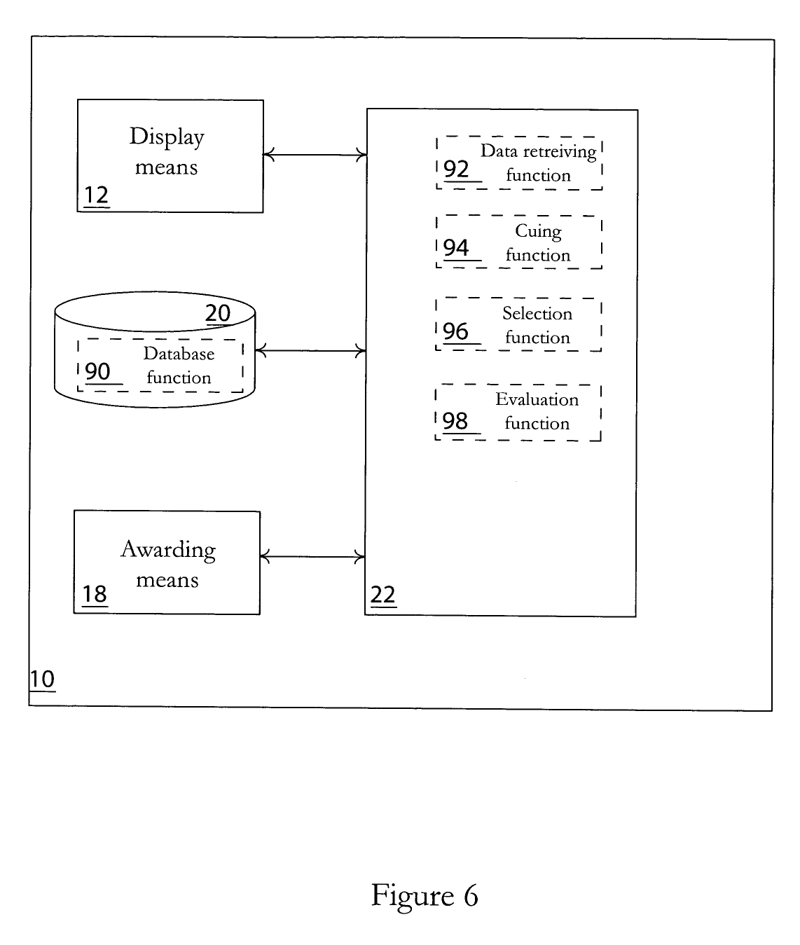

Such method requires from the gaming machine to complete certain functions. These functions, illustrated on FIG. 6, comprise: (a) a database function 90: memory means 20 storing a time weighted database in which cuing times are kept; (b) data retrieving function 92: game controller means 22 retrieving from said database information, for instance the cuing order and the cuing time; (c) cuing function 94: game controller means 22 controlling the cuing process; (d) selection function 96: game controller means 22 receiving a stop signal and ending the cuing process; and (e) evaluation function 98: game controller means 22 establishing a game outcome based on the selected indicium that is the indicium cued at the time the stop signal is received. Depending on the alternative embodiments that may be added to the above process, other functions may be necessary.

It is intended that one skilled in the art of the invention may include variations in the disclosed method or a disclosed machine to render adapt it to his desired realization. Examples of such variations may include to provide indicia in a combination of imprinted and dynamic display, to cue the indicia in a predetermined cyclic order or in a random order; to randomly establish the cuing time according to cuing data such as average cuing time for each indicia; to prevent players to stop the cuing process in some circumstances, such as before or after predetermined times; to require players to enter a series of commands or a particular command based on some displayed information within a predetermined time for the stop signal to be generated; and to provide the present game either as a single game such a promotional game or a dependent game being initiated upon occurrence of a trigger outcome in a primary game.

While the appended block diagrams illustrates the present invention as groups of discrete components communicating with each other via distinct data signal connections, it will be understood by those skilled in the art that the invention may be embodied through a combination of hardware and software components, with some components being implemented by a given function or operation of a hardware or software system, and many of the data paths illustrated being implemented by data communication within a computer application or operating system. The structure illustrated is thus provided for efficiency of teaching the embodiments of the invention.

It should be noted that the present invention can be carried out as a method, can be embodied in a system, a computer readable medium, a processing-readable memory, or an electrical or electromagnetic signal.

The embodiments of the invention described above are intended to be exemplary only. The scope of the invention is therefore intended to be limited solely by the scope of the appended claims.

I/we claim:

1. A method of providing a player-activated game comprising:
providing a plurality of visually distinguishable indicia to a player;
visually cuing said indicia one at a time in a time-weighted manner thereby establishing uneven indicium selection difficulty;
receiving a stop signal from the player, said signal resulting in a selection of the visually cued indicium when said stop signal is received; and
establishing a game outcome based on said indicium selection.

2. The method of claim 1, further comprising establishing a cuing order of said indicia.

3. The method of claim 2, further comprising randomly establishing said cuing order.

4. The method of claim 3, wherein said step of providing indicia is performed on a display wherein said indicia are provided in a non-cyclic structure thereby cuing said indicia in their cuing order results in an apparent unordered wandering through said display.

5. The method of claim 2, further comprising incorporating an indicium within said cuing order at least twice.

6. The method of claim 2, wherein said cuing order involves a cycle.

7. The method of claim 6, wherein said step of receiving a stop signal is authorized after cuing a predetermined number of indicia.

8. The method of claim 1, further establishing a time limit to receive the stop signal.

9. The method of claim 1, wherein said stop signal comprises at least one of: (a) completion of a series of predetermined commands, and (b) completion of a game information dependent command.

10. The method of claim 1, wherein the outcome establishment comprises at least one of: (a) establishing a prize value, (b) comparing the selected indicium with comparison data, and (c) comparing selection time with comparison data.

11. The method of claim 1, further comprising randomly establishing cuing time of an indicium.

12. The method of claim 1, wherein at least two indicium selections are necessary to establish a game outcome.

13. The method of claim 1, performed on a gaming machine.

14. The method of claim 1, performed on a gaming device communicatively linked to a gaming machine.

15. The method of claim 1, wherein said method is performed upon occurrence of a trigger outcome in a primary game.

16. A gaming machine for providing a player-activated game comprising:
display means providing a plurality of visually distinguishable indicia to a player;
control means for receiving a stop signal from the player; and
game controller means for providing a play of said game,
wherein said game controller means is adapted:
(a) to visually cue the indicia one at a time in an uneven time weighted manner thereby establishing uneven indicium selection difficulty;
(b) to stop the cuing process upon reception of a stop signal, resulting in a selection of the cued indicium upon reception of said stop signal; and
(c) to establish a game outcome based on said selected indicium.

17. The gaming machine of claim 16, further comprising awarding means rewarding the player with the game outcome in a suitable format.

18. The gaming machine of claim 16, wherein the game controller means is further adapted to establish an indicium cuing order.

19. The gaming machine of claim 18, wherein said order is cyclic.

20. The gaming machine of claim 18, wherein the game controller means is further adapted to authorize reception of a stop signal from the player when a predetermined number of indicia has been cued.

21. The gaming machine of claim 16, wherein said display means includes a display glass with imprinted indicia thereon and game controller means controlled lamps located beneath each indicium, wherein highlighting a lamp beneath an indicium results in cuing said indicium.

22. The gaming machine of claim 16, adapted to be communicatively linked to a first gaming machine providing a primary game and wherein said game controller means initiates the play of said player-activated game upon occurrence of a trigger outcome in the primary game.

23. The gaming machine of claim 22, wherein said control means is embodied in a signal communication route between said gaming machine and the first gaming machine, said embodiment allowing actuation of a first gaming machine player input to be interpreted by the game controller means as a stop signal.

24. The gaming machine of claim 16, wherein said game controller means is further adapted (a) to provide a primary game, (b) to evaluate primary game outcome, and (c) to initiate a play of the player-activated game upon occurrence of a trigger outcome in said primary game.

25. A computer program embodied in an electric or an electromagnetic carrier signal having codes adapted, when performed by a CPU of a device:
to visually cue an indicium at a time in a time-weighted manner a plurality of visually distinguishable indicia, thereby establishing uneven indicium selection difficulty;
to receive a stop signal from the player, said signal resulting in a selection of the visually cued indicium when said stop signal is received; and
to establish a game outcome based on said indicium selection.

26. A computer program embodied on a computer readable medium or processor-readable memory having codes adapted, when performed by a CPU of a device:
to visually cue an indicium at a time in a time-weighted manner a plurality of visually distinguishable indicia, thereby establishing uneven indicium selection difficulty;
to receive a stop signal from the player, said signal resulting in a selection of the visually cued indicium when said stop signal is received; and
to establish a game outcome based on said indicium selection.
